(19) United States
(12) Patent Application Publication
(10) Pub. No.: US 2014/0002608 A1
(43) Pub. Date: Jan. 2, 2014

(54) LINE SCANNER USING A LOW COHERENCE LIGHT SOURCE

(71) Applicant: FARO Technologies, Inc., (US)

(72) Inventors: Paul C. Atwell, Lake Mary, FL (US); Clark H. Briggs, DeLand, FL (US); Burnham Stokes, Lake Mary, FL (US)

(73) Assignee: FARO TECHNOLOGIES, INC., Lake Mary, FL (US)

(21) Appl. No.: 13/721,169

(22) Filed: Dec. 20, 2012

Related U.S. Application Data
(60) Provisional application No. 61/580,817, filed on Dec. 28, 2011.

(51) Int. Cl. G01B 11/24

(52) U.S. Cl. CPC G01B 11/24
USPC 348/46

(57) ABSTRACT

A line scanner configured to measure an object is provided. The scanner includes a non-laser light source, a beam delivery system and a mask. The beam delivery system is configured to deliver the light from the light source to the mask. The mask includes an opaque portion and a transmissive region in the shape of a line. A first lens system is configured to image the light from the mask onto the object. A camera that includes a second lens system and a photosensitive array, wherein the second lens system is configured to collect the light reflected by or scattered off the object as a first collected light and image the first collected light onto the photosensitive array. A housing is provided and an electronic circuit including a processor. The electronic circuit is configured to calculate three dimensional coordinates of a plurality of points of light imaged on the object.

### BACKGROUND

The present disclosure relates to a line scanner, and more particularly to a line scanner that utilizes a non-laser light source, wherein the line scanner may be for use instead of a traditional laser line probe in various non-contact object inspection or measurement configurations; for example, in conjunction with a portable articulated arm coordinate measuring machine or in a fixed (i.e., non-movable) inspection installation (e.g., an automobile assembly line).

Portable articulated arm coordinate measuring machines (AACMMs) have found widespread use in the manufacturing or production of parts where there is a need to rapidly and accurately verify the dimensions of the part during various stages of the manufacturing or production (e.g., machining) of the part. Portable AACMMs represent a vast improvement over known stationary or fixed, cost-intensive and relatively difficult to use measurement installations, particularly in the amount of time it takes to perform dimensional measurements of relatively complex parts. Typically, a user of a portable AACMM simply guides a probe along the surface of the part or object to be measured. The measurement data are then recorded and provided to the user. In some cases, the data are provided to the user in visual form, for example, three-dimensional (3-D) form on a computer screen. In other cases, the data are provided to the user in numeric form, for example when measuring the diameter of a hole, the text “Diameter=1.0034” is displayed on a computer screen.

An example of a prior art portable articulated arm CMM is disclosed in commonly assigned U.S. Pat. No. 5,402,582 ('582), which is incorporated herein by reference in its entirety. The '582 patent discloses a 3-D measuring system comprised of a manually-operated articulated arm CMM having a support base on one end and a measurement probe at the other end. Commonly assigned U.S. Pat. No. 5,611,147 ('147), which is incorporated herein by reference in its entirety, discloses a similar articulated arm CMM. In the '147 patent, the articulated arm CMM includes a number of features including an additional rotational axis at the probe end, thereby providing for an arm with either a two-two-two or a two-two-three axis configuration (the latter case being a seven axis arm). Commonly assigned U.S. Patent Publication No. 2011/0119026 ('026), which is incorporated herein by reference in its entirety, discloses a laser line scanner, also known as a laser line probe (LLP), attached to a manually-operated articulated arm CMM, the laser line scanner capable of collecting three-dimensional information about the surface of an object without making direct contact with the object.

It is known to attach various accessory devices to a CMM. For example, it is known to attach a laser line probe (LLP) to a CMM. The LLP is a type of a non-contacting line scanner. The LLP typically projects a laser line that is straight to obtain 3D features of an object without the line scanner having a probe that must come into physical contact with the object to take measurements. In the past, the projected straight line has had a particular color, such as red, characteristic of the wavelength of a laser source used to provide the light. The method or means of attachment and the attachment point of the LLP to the CMM can vary. However, it is common to attach the LLP in the vicinity of the probe end of the CMM, for example, near a fixed “hard” probe that contacts the object to be measured. Generally, the LLP takes many more data points of the object being measured than the hard probe takes.

It is also common for the LLP to utilize a coherent light source, such as a laser, in conjunction with a type of lens, such as a rod lens, to focus the projected straight line of light onto the object being measured. This light is picked up by a camera spaced some distance away from the projector. However, problems exist with the use of a laser as the light source for a light scanner. For example, the laser inherently generates speckle noise, which is a kind of noise that produces a kind of blotchy or speckled illumination pattern on the photosensitive array of the camera. As a result of the speckle noise, the position of the line at the camera cannot be calculated as accurately as would otherwise be the case. Consequently there is an increase in the error of the three-dimensional coordinate values measured by the LLP. Speckle noise may also blur the edges of the line pattern intercepted by the camera, and the projected line pattern may be thicker than desired with some amount of non-uniformity and decay at the ends.

While existing CMM's with accessory devices such as an LLP attached are suitable for their intended purposes, what is needed is a portable AACMM that accommodates a line scanner connected to the AACMM, and fixed inspection installations that utilize one or more line scanners, wherein the line scanner has certain light source features of embodiments of the present invention.

### SUMMARY OF THE INVENTION

In accordance with an embodiment of the invention, a line scanner configured to measure an object includes a non-laser light source that emits light, a beam delivery system, and a mask, wherein the beam delivery system is configured to deliver the light from the light source to the mask, and wherein the mask is substantially opaque to the light from the beam delivery system except in a single transmissive region through which the light is transmitted, the transmissive region being substantially in the shape of a line. The line scanner also includes a first lens system configured to image the light from the mask onto the object, and a camera that includes a second lens system and a photosensitive array, the camera having predetermined characteristics including a focal length of the second lens system and a position of the photosensitive array relative to the second lens system, and wherein the second lens system is configured to collect the light reflected by or scattered off the object as a first collected light and image the first collected light onto the photosensitive array, the photosensitive array configured to convert the first collected light into an electrical signal. The line scanner further includes a housing to which are attached in a rigid and predetermined geometrical configuration the non-laser light source, the beam delivery system, the mask, the first lens system, and the camera. The line scanner also includes an electronic circuit including a processor, wherein the electronic circuit is configured to calculate three dimensional coordinates of a plurality of points of light imaged on the object by the first lens system, the three dimensional coordinates based at least in part on the electrical signal, the camera characteristics, and the geometrical configuration.

In accordance with another embodiment of the invention, a line scanner configured to measure an object includes a non-laser light source that emits light, and a beam delivery system, the beam delivery system configured to form the light into a single line of light perpendicular to the direction of propagation. The line scanner also includes a first lens system configured to image the single line of light onto the object, and a camera that includes a second lens system and a photosensitive array, the camera having predetermined characteristics including a focal length of the second lens system and a position of the photosensitive array relative to the second lens system, and wherein the second lens system is configured to collect the light reflected by or scattered off the object as a first collected light and image the first collected light onto the photosensitive array, the photosensitive array configured to convert the first collected light into an electrical signal. The line scanner further includes a housing to which are attached in a rigid and predetermined geometrical configuration the non-laser light source, the beam delivery system, the first lens system, and the camera, and an electronic circuit including a processor, wherein the electronic circuit is configured to calculate three dimensional coordinates of a plurality of points of light imaged on the object by the first lens system, the three dimensional coordinates based at least in part on the electrical signal, the camera characteristics, and the geometrical configuration.

In accordance with yet another embodiment of the invention, a line scanner configured to measure an object includes a non-laser light source that emits light, a beam deflector, and a beam delivery system, the beam delivery system configured to image the light from the light source into a small spot of light on the beam deflector. The line scanner also includes a first lens system configured to image the small spot of light on the beam deflector onto the object, the beam deflector configured to sweep the spot on the object to produce a line, and a camera that includes a second lens system and a photosensitive array, the camera having predetermined characteristics including a focal length of the second lens system and a position of the photosensitive array relative to the second lens system, and wherein the second lens system is configured to collect the light reflected by or scattered off the object as a first collected light and image the first collected light onto the photosensitive array, the photosensitive array configured to convert the first collected light into an electrical signal. The line scanner further includes a housing to which are attached in a rigid and predetermined geometrical configuration the non-laser light source, the beam delivery system, the first lens system, the beam deflector, and the camera, and an electronic circuit including a processor, wherein the electronic circuit is configured to calculate three dimensional coordinates of a plurality of spots of light imaged on the object by the first lens system, the three dimensional coordinates based at least in part on the electrical signal, the camera characteristics, and the geometrical configuration.

In accordance with still another embodiment of the invention, a portable articulated arm coordinate measuring machine for measuring the coordinates of an object in space includes a manually positionable articulated arm having opposed first and second ends, the arm portion including a plurality of connected arm segments, each arm segment including at least one position transducer for producing a position signal. The portable articulated arm coordinate measuring machine also includes a base section connected to the second end, and a probe assembly connected to the first end, the probe assembly including a line scanner that scans the object in space. The line scanner includes a projector that images light on the object in a single line perpendicular to the direction of propagation of the light, the projector including a non-laser light source, and a camera that includes a lens system and a photosensitive array, the camera having predetermined characteristics including a focal length of the lens system and a position of the photosensitive array relative to the lens system, and wherein the lens system is configured to collect the light reflected by or scattered off the object as a first collected light and image the first collected light onto the photosensitive array, the photosensitive array configured to convert the first collected light into an electrical signal. The line scanner also includes a housing to which are attached in a rigid and predetermined geometrical configuration the projector and the camera, and an electronic circuit including a processor, wherein the electronic circuit is configured to calculate three dimensional coordinates of a plurality of points of light imaged on the object by the first lens system, the three dimensional coordinates based at least in part on the electrical signal, the camera characteristics, and the geometrical configuration.

In accordance with still another embodiment of the invention, a line scanner configured to measure an object is provided. The line scanner includes a non-laser light source that emits light and a beam delivery system. An apodizing filter is arranged to receive light from the beam delivery system, the apodizing filter configured to output the light received from the beam delivery system in substantially the shape of a single line of light, the single line of light perpendicular to the direction of propagation of the light. A first lens system is configured to receive the single line of light from the apodizing filter and image the single line of light onto the object. A camera is provided that includes a second lens system and a photosensitive array. The camera having predetermined characteristics including a focal length of the second lens system and a position of the photosensitive array relative to the second lens system, and wherein the second lens system is configured to collect the light reflected by or scattered off the object as a first collected light and image the first collected light onto the photosensitive array. The photosensitive array is configured to convert the first collected light into an electrical signal. A housing is provided to which is attached in a rigid and predetermined geometrical configuration the non-laser light source, the beam delivery system, the first lens system, and the camera. An electronic circuit is provided that includes a processor. The electronic circuit is configured to calculate three dimensional coordinates of a plurality of points of light imaged on the object by the first lens system, the points of light being a part of the light imaged onto the object, the three dimensional coordinates based at least in part on the electrical signal, the camera characteristics, and the geometrical configuration.

### BRIEF DESCRIPTION OF THE DRAWINGS

Referring now to the drawings, exemplary embodiments are shown which should not be construed to be limiting regarding the entire scope of the disclosure, and wherein the elements are numbered alike in several FIGURES:

FIG. 1, including FIGS. 1A and 1B, are perspective views of a portable articulated arm coordinate measuring machine (AACMM) having embodiments of various aspects of the present invention therewithin;

FIG. 2, including FIGS. 2A-2D taken together, is a block diagram of electronics utilized as part of the AACMM of FIG. 1 in accordance with an embodiment;

FIG. 3, including FIGS. 3A and 3B taken together, is a block diagram describing detailed features of the electronic data processing system of FIG. 2 in accordance with an embodiment;

FIG. 4 is an isometric view of the probe end of the AACMM of FIG. 1;

FIG. 5 is a side view of the probe end of FIG. 4 with the handle being coupled thereto;

FIG. 6 is a partial side view of the probe end of FIG. 4 with the handle attached;

FIG. 7 is an enlarged partial side view of the interface portion of the probe end of FIG. 6;

FIG. 8 is another enlarged partial side view of the interface portion of the probe end of FIG. 5;

FIG. 9 is an isometric view partially in section of the handle of FIG. 4;

FIG. 10 is an isometric view of the probe end of the AACMM of FIG. 1 with a line scanner device attached;

FIG. 11 is an isometric view partially in section of the line scanner device of FIG. 10;

FIG. 12, including FIGS. 12A-D, are schematic diagrams of the line scanner device of FIG. 11 that includes a non-laser line source which is used to project a single line onto an object to be measured, in accordance with embodiments of the present invention;

FIG. 13, including FIGS. 13A and 13B, are illustrations based on laboratory data of a laser stripe having normal and reduced levels of laser speckle; and

FIG. 14 is a schematic diagram illustrating how the line scanner device of FIG. 11 determines distance from the scanner to an object in accordance with another embodiment of the present invention.

### DETAILED DESCRIPTION

Portable articulated arm coordinate measuring machines (“AACMM”) are used in a variety of applications to obtain measurements of objects. Embodiments of the present invention provide advantages in allowing an operator to utilize an AACMM with a line scanner attached thereto, wherein the line scanner utilizes a non-laser light source to achieve improvements over prior art laser line probes that utilize lasers as the light source. However, embodiments of the present invention are not limited for use with portable AACMMS. Instead, line scanners in accordance with embodiments of the present invention may be utilized as part of, or in conjunction with many other types of devices, such as non-articulated arm CMMs, and in fixed inspection installations such as at various fixed points along an automobile assembly line.

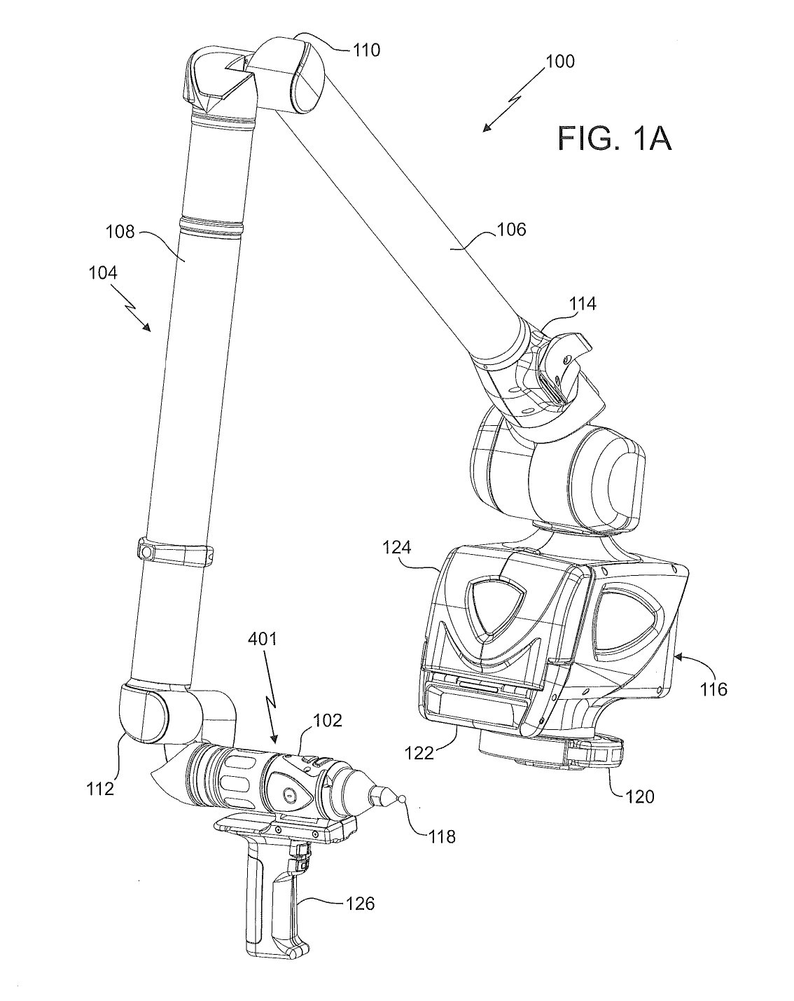

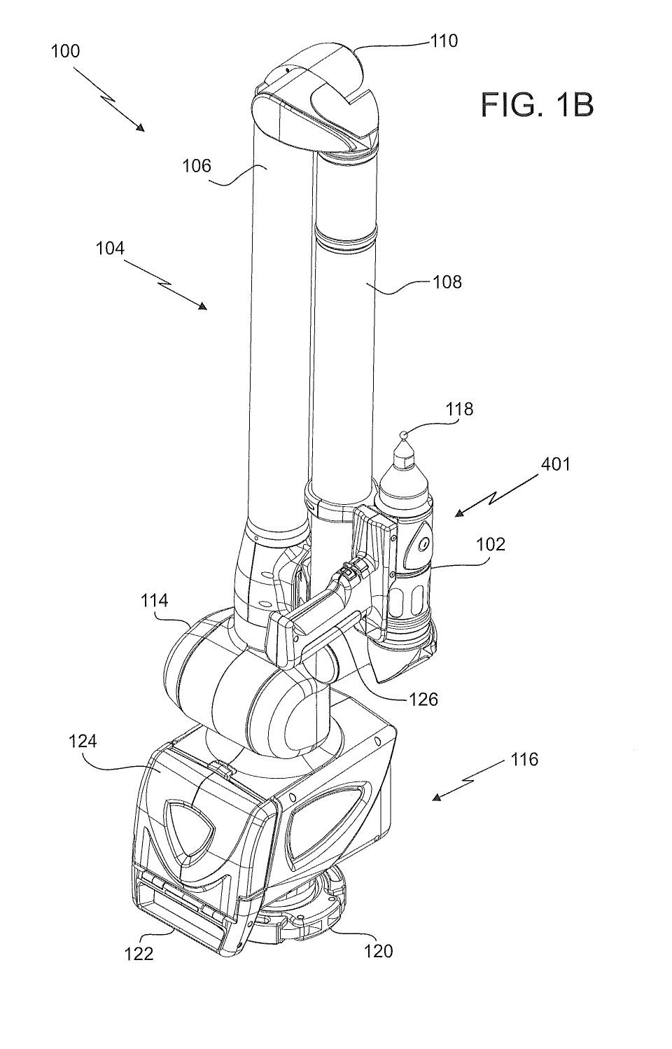

FIGS. 1A and 1B illustrate, in perspective, an AACMM 100 according to various embodiments of the present invention, an articulated arm being one type of coordinate measuring machine. As shown in FIGS. 1A and 1B, the exemplary AACMM 100 may comprise a six or seven axis articulated measurement device having a probe end 401 that includes a measurement probe housing 102 coupled to an arm portion 104 of the AACMM 100 at one end. The arm portion 104 comprises a first arm segment 106 coupled to a second arm segment 108 by a first grouping of bearing cartridges 110 (e.g., two bearing cartridges). A second grouping of bearing cartridges 112 (e.g., two bearing cartridges) couples the second arm segment 108 to the measurement probe housing 102. A third grouping of bearing cartridges 114 (e.g., three bearing cartridges) couples the first arm segment 106 to a base 116 located at the other end of the arm portion 104 of the AACMM 100. Each grouping of bearing cartridges 110, 112, 114, provides for multiple axes of articulated movement. Also, the probe end 401 may include a measurement probe housing 102 that comprises the shaft of the seventh axis portion of the AACMM 100 (e.g., a cartridge containing an encoder system that determines movement of the measurement device, for example a probe 118, in the seventh axis of the AACMM 100). In this embodiment, the probe end 401 may rotate about an axis extending through the center of measurement probe housing 102. In use of the AACMM 100, the base 116 is typically affixed to a work surface.

Each bearing cartridge within each bearing cartridge grouping 110, 112, 114, typically contains an encoder system (e.g., an optical angular encoder system). The encoder system (i.e., transducer) provides an indication of the position of the respective arm segments 106, 108 and corresponding bearing cartridge groupings 110, 112, 114, that all together provide an indication of the position of the probe 118 with respect to the base 116 (and, thus, the position of the object being measured by the AACMM 100 in a certain frame of reference—for example a local or global frame of reference). The arm segments 106, 108 may be made from a suitably rigid material such as but not limited to a carbon composite material for example. A portable AACMM 100 with six or seven axes of articulated movement (i.e., degrees of freedom) provides advantages in allowing the operator to position the probe 118 in a desired location within a 360° area about the base 116 while providing an arm portion 104 that may be easily handled by the operator. However, it should be appreciated that the illustration of an arm portion 104 having two arm segments 106, 108 is for exemplary purposes, and the claimed invention should not be so limited. An AACMM 100 may have any number of arm segments coupled together by bearing cartridges (and, thus, more or less than six or seven axes of articulated movement or degrees of freedom).

The probe 118 is detachably mounted to the measurement probe housing 102, which is connected to bearing cartridge grouping 112. A handle 126 is removable with respect to the measurement probe housing 102 by way of, for example, a quick-connect interface. The handle 126 may be replaced with another device (e.g., a line scanner in accordance with embodiments of the present invention, as described in detail hereinafter), thereby providing advantages in allowing the operator to use different measurement devices with the same AACMM 100. In exemplary embodiments, the probe housing 102 houses a removable probe 118, which is a contacting measurement device and may have different tips 118 that physically contact the object to be measured, including, but not limited to: ball, touch-sensitive, curved and extension type probes. In other embodiments, the measurement is performed, for example, by a non-contacting device such as a laser line probe (LLP) or the aforementioned line scanner. In certain embodiments of the present invention, the handle 126 is replaced with the line scanner using the quick-connect interface.

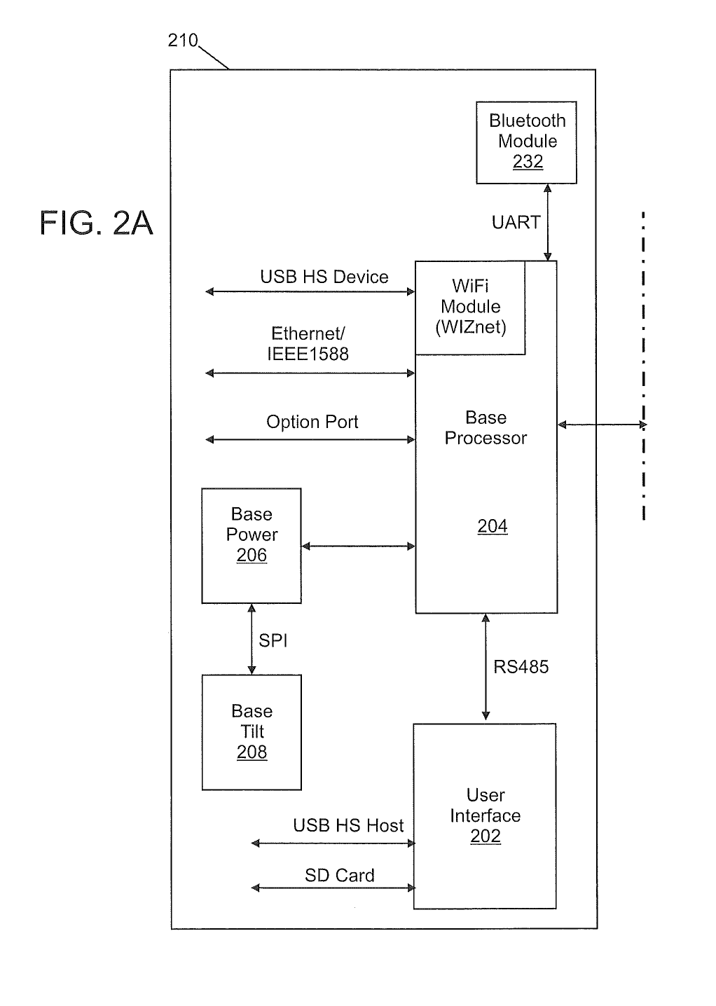

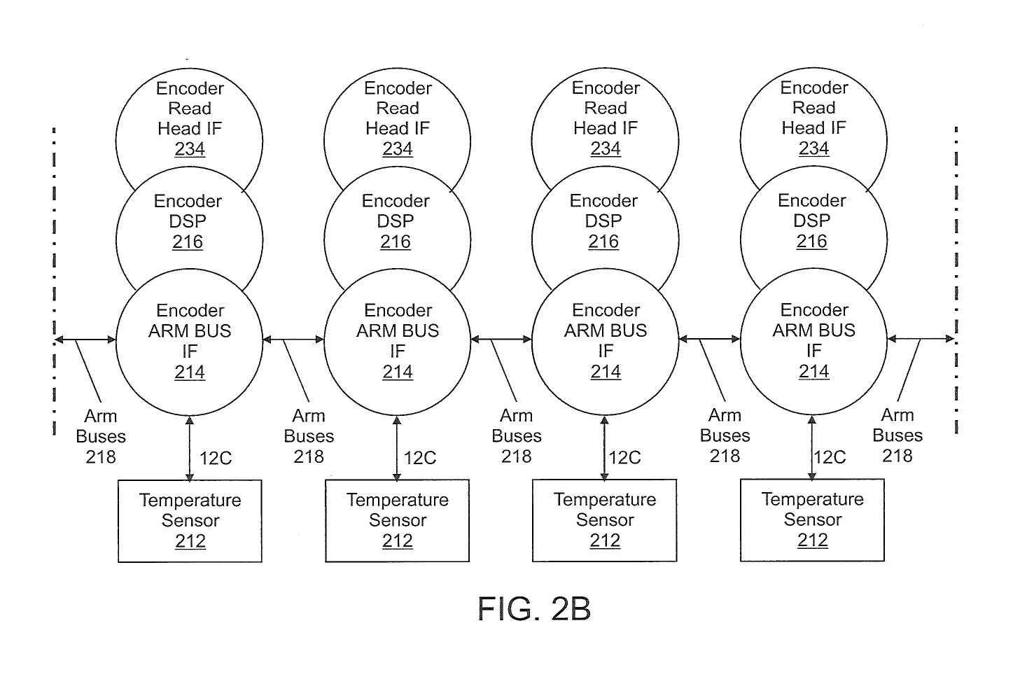

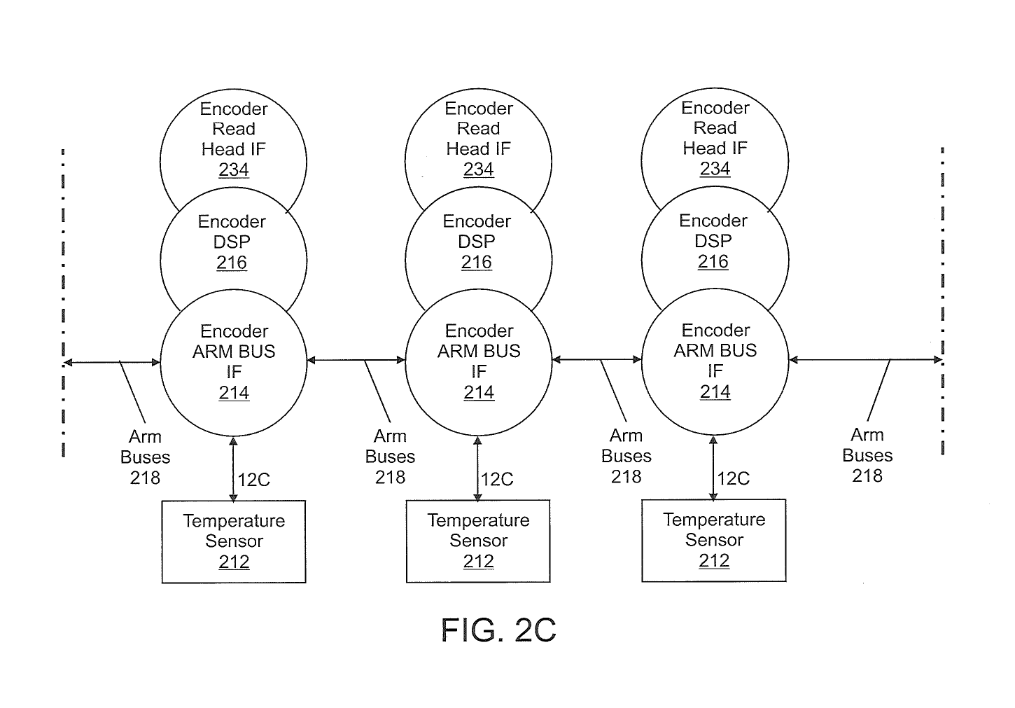

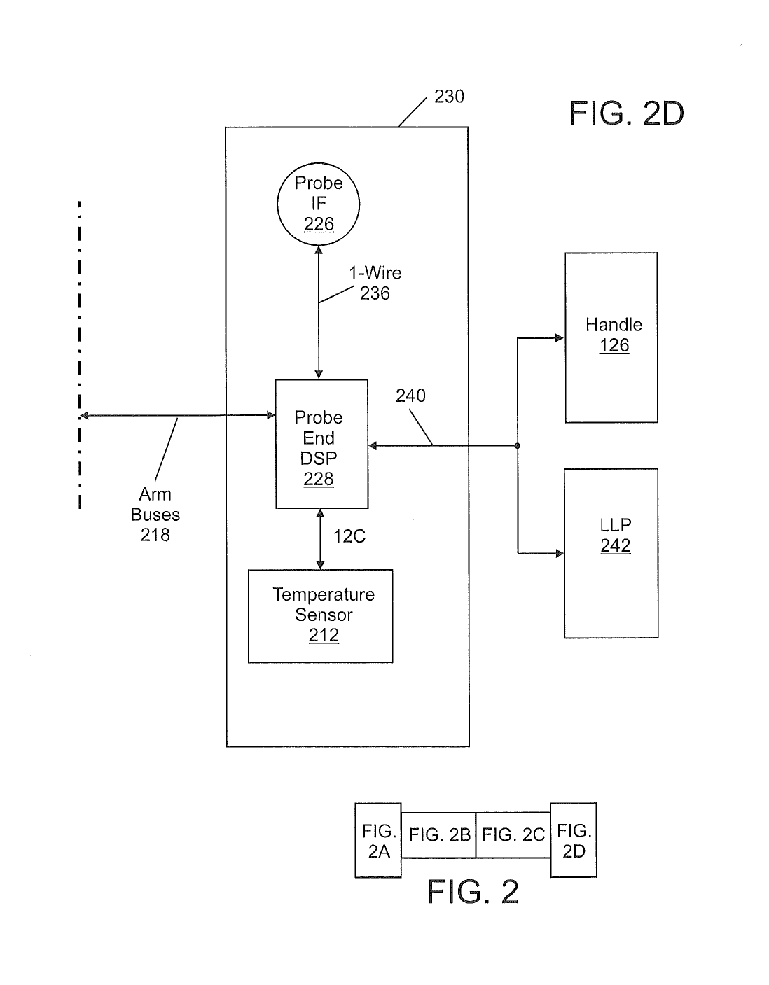

As shown in FIGS. 1A and 1B, the AACMM 100 includes the removable handle 126 that provides advantages in allowing accessories or functionality to be changed without removing the measurement probe housing 102 from the bearing cartridge grouping 112. As discussed in more detail below with respect to FIG. 2, the removable handle 126 may also include an electrical connector that allows electrical power and data to be exchanged with the handle 126 and the corresponding electronics located in the probe end 401.

In various embodiments, each grouping of bearing cartridges 110, 112, 114, allows the arm portion 104 of the AACMM 100 to move about multiple axes of rotation. As mentioned, each bearing cartridge grouping 110, 112, 114, includes corresponding encoder systems, such as optical angular encoders for example, that are each arranged coaxially with the corresponding axis of rotation of, e.g., the arm segments 106, 108. The optical encoder system detects rotational (swivel) or transverse (hinge) movement of, e.g., each one of the arm segments 106, 108 about the corresponding axis and transmits a signal to an electronic data processing system within the AACMM 100 as described in more detail herein below. Each individual raw encoder count is sent separately to the electronic data processing system as a signal where it is further processed into measurement data. No position calculator separate from the AACMM 100 itself (e.g., a serial box) is required, as disclosed in commonly assigned U.S. Pat. No. 5,402,582 ('582).

The base 116 may include an attachment device or mounting device 120. The mounting device 120 allows the AACMM 100 to be removably mounted to a desired location, such as an inspection table, a machining center, a wall or the floor for example. In one embodiment, the base 116 includes a handle portion 122 that provides a convenient location for the operator to hold the base 116 as the AACMM 100 is being moved. In one embodiment, the base 116 further includes a movable cover portion 124 that folds down to reveal a user interface, such as a display screen.

In accordance with an embodiment, the base 116 of the portable AACMM 100 contains or houses an electronic data processing system that includes two primary components: a base processing system that processes the data from the various encoder systems within the AACMM 100 as well as data representing other arm parameters to support three-dimensional (3-D) positional calculations; and a user interface processing system that includes an on-board operating system, a touch screen display, and resident application software that allows for relatively complete metrology functions to be implemented within the AACMM 100 without the need for connection to an external computer.

The electronic data processing system in the base 116 may communicate with the encoder systems, sensors, and other peripheral hardware located away from the base 116 (e.g., a line scanner that is mounted on the AACMM 100 in place of the removable handle 126, as described in detail hereinafter). The electronics that support these peripheral hardware devices or features may be located in each of the bearing cartridge groupings 110, 112, 114, located within the portable AACMM 100.

FIG. 2 is a block diagram of electronics utilized in an AACMM 100 in accordance with an embodiment. The embodiment shown in FIG. 2 includes an electronic data processing system 210 including a base processor board 204 for implementing the base processing system, a user interface board 202, a base power board 206 for providing power, a Bluetooth module 232, and a base tilt board 208. The user interface board 202 includes a computer processor for executing application software to perform user interface, display, and other functions described herein.

As shown in FIG. 2, the electronic data processing system 210 is in communication with the aforementioned plurality of encoder systems via one or more arm buses 218. In the embodiment depicted in FIG. 2, each encoder system generates encoder data and includes: an encoder arm bus interface 214, an encoder digital signal processor (DSP) 216, an encoder read head interface 234, and a temperature sensor 212. Other devices, such as strain sensors, may be attached to the arm bus 218.

Also shown in FIG. 2 are probe end electronics 230 that are in communication with the arm bus 218. The probe end electronics 230 include a probe end DSP 228, a temperature sensor 212, a handle/LLP interface bus 240 that connects with the handle 126, the LLP 242 or the line scanner via the quick-connect interface in an embodiment, and a probe interface 226. The quick-connect interface allows access by the handle 126 to the data bus, control lines, and power bus used by the LLP 242, line scanner and other accessories. In an embodiment, the probe end electronics 230 are located in the measurement probe housing 102 on the AACMM 100. In an embodiment, the handle 126 may be removed from the quick-connect interface and measurement may be performed by the line scanner or laser line probe (LLP) 242 communicating with the probe end electronics 230 of the AACMM 100 via the handle/LLP interface bus 240. In an embodiment, the electronic data processing system 210 is located in the base 116 of the AACMM 100, the probe end electronics 230 are located in the measurement probe housing 102 of the AACMM 100, and the encoder systems are located in the bearing cartridge groupings 110, 112, 114. The probe interface 226 may connect with the probe end DSP 228 by any suitable communications protocol, including commercially-available products from Maxim Integrated Products, Inc. that embody the 1-wire® communications protocol 236.

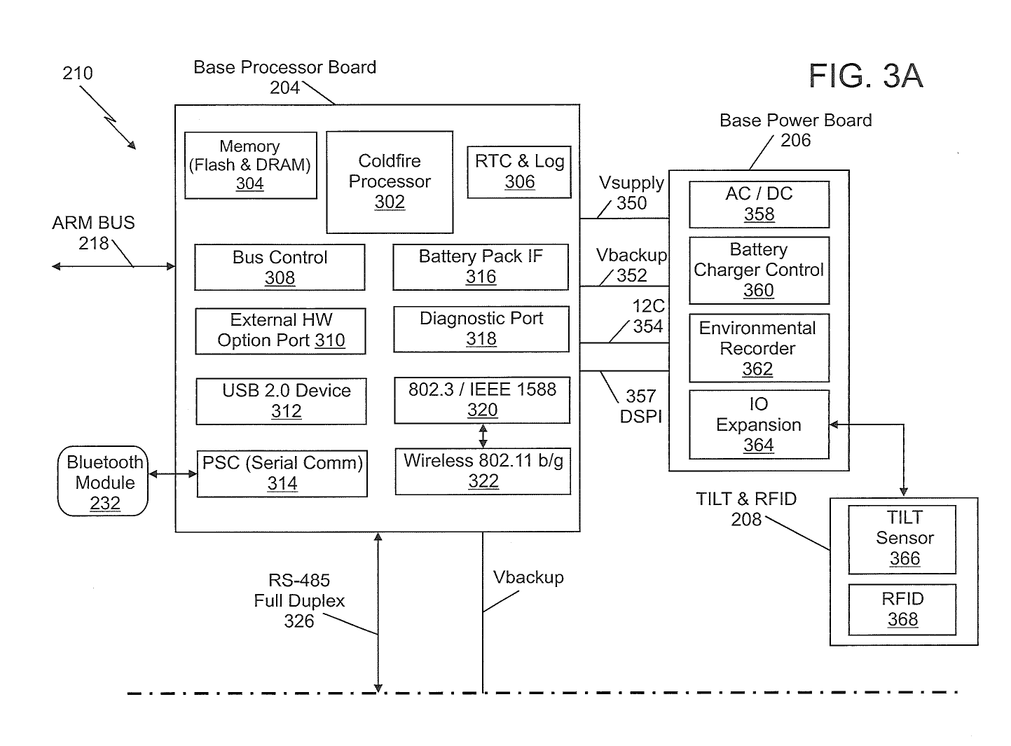

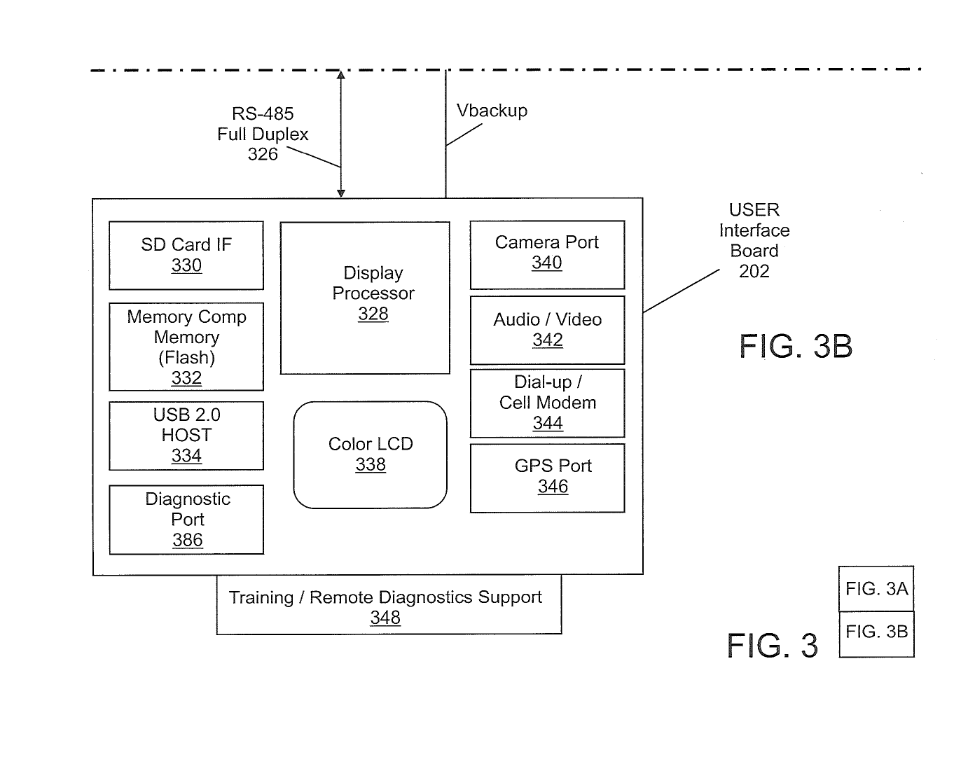

FIG. 3 is a block diagram describing detailed features of the electronic data processing system 210 of the AACMM 100 in accordance with an embodiment. In an embodiment, the electronic data processing system 210 is located in the base 116 of the AACMM 100 and includes the base processor board 204, the user interface board 202, a base power board 206, a Bluetooth module 232, and a base tilt module 208.

In an embodiment shown in FIG. 3, the base processor board 204 includes the various functional blocks illustrated therein. For example, a base processor function 302 is utilized to support the collection of measurement data from the AACMM 100 and receives raw arm data (e.g., encoder system data) via the arm bus 218 and a bus control module function 308. The memory function 304 stores programs and static arm configuration data. The base processor board 204 also includes an external hardware option port function 310 for communicating with any external hardware devices or accessories such as a line scanner or an LLP 242. A real time clock (RTC) and log 306, a battery pack interface (IF) 316, and a diagnostic port 318 are also included in the functionality in an embodiment of the base processor board 204 depicted in FIG. 3.

The base processor board 204 also manages all the wired and wireless data communication with external (host computer) and internal (display processor 202) devices. The base processor board 204 has the capability of communicating with an Ethernet network via an Ethernet function 320 (e.g., using a clock synchronization standard such as Institute of Electrical and Electronics Engineers (IEEE) 1588), with a wireless local area network (WLAN) via a LAN function 322, and with Bluetooth module 232 via a parallel to serial communications (PSC) function 314. The base processor board 204 also includes a connection to a universal serial bus (USB) device 312.

The base processor board 204 transmits and collects raw measurement data (e.g., encoder system counts, temperature readings) for processing into measurement data without the need for any preprocessing, such as disclosed in the serial box of the aforementioned '582 patent. The base processor 204 sends the processed data to the display processor 328 on the user interface board 202 via an RS485 interface (IF) 326. In an embodiment, the base processor 204 also sends the raw measurement data to an external computer.

Turning now to the user interface board 202 in FIG. 3, the angle and positional data received by the base processor is utilized by applications executing on the display processor 328 to provide an autonomous metrology system within the AACMM 100. Applications may be executed on the display processor 328 to support functions such as, but not limited to: measurement of features, guidance and training graphics, remote diagnostics, temperature corrections, control of various operational features, connection to various networks, and display of measured objects. Along with the display processor 328 and a liquid crystal display (LCD) 338 (e.g., a touch screen LCD) user interface, the user interface board 202 includes several interface options including a secure digital (SD) card interface 330, a memory 332, a USB Host interface 334, a diagnostic port 336, a camera port 340, an audio/video interface 342, a dial-up/cell modem 344 and a global positioning system (GPS) port 346.

The electronic data processing system 210 shown in FIG. 3 also includes a base power board 206 with an environmental recorder 362 for recording environmental data. The base power board 206 also provides power to the electronic data processing system 210 using an AC/DC converter 358 and a battery charger control 360. The base power board 206 communicates with the base processor board 204 using inter-integrated circuit (12C) serial single ended bus 354 as well as via a DMA serial peripheral interface (DSPI) 356. The base power board 206 is connected to a tilt sensor and radio frequency identification (RFID) module 208 via an input/output (I/O) expansion function 364 implemented in the base power board 206.

Though shown as separate components, in other embodiments all or a subset of the components may be physically located in different locations and/or functions combined in different manners than that shown in FIG. 3. For example, in one embodiment, the base processor board 204 and the user interface board 202 are combined into one physical board.

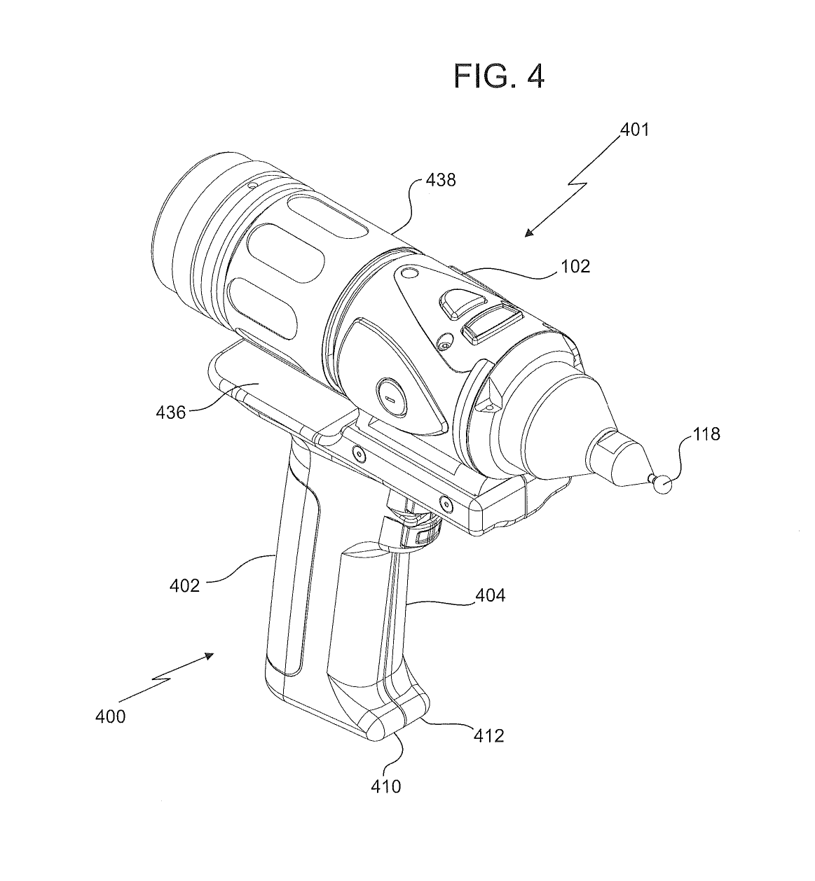

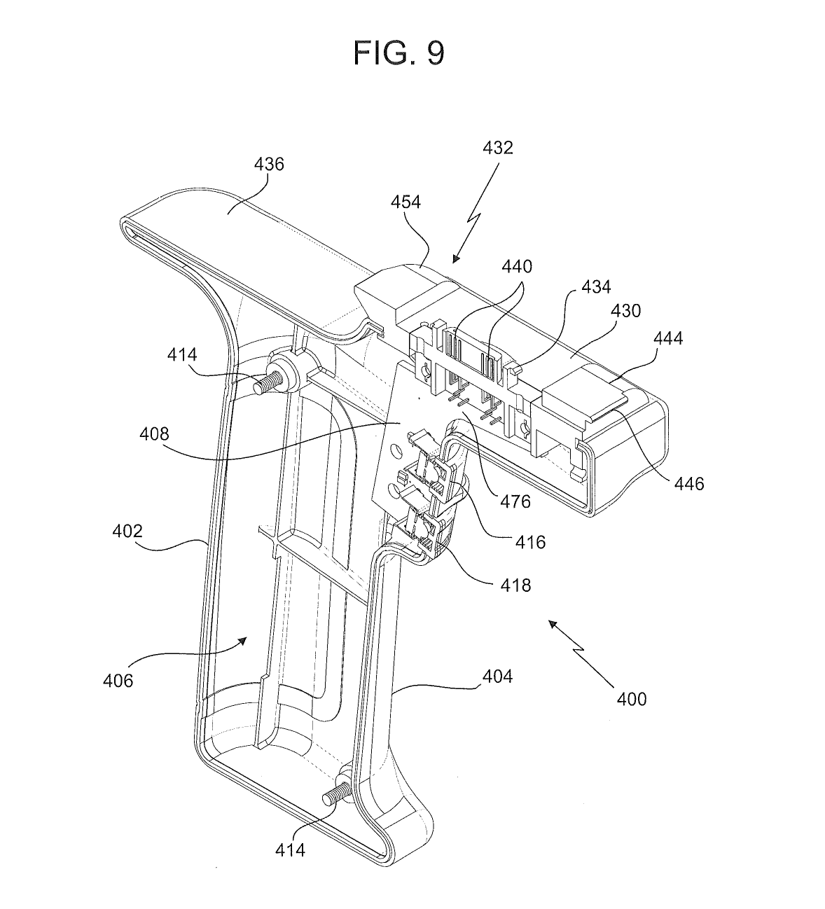

Referring now to FIGS. 4-9, an exemplary embodiment of a probe end 401 is illustrated having a measurement probe housing 102 with a quick-connect mechanical and electrical interface that allows removable and interchangeable device 400 to couple with AACMM 100. In the exemplary embodiment, the device 400 includes an enclosure 402 that includes a handle portion 404 that is sized and shaped to be held in an operator's hand, such as in a pistol grip for example. The enclosure 402 is a thin wall structure having a cavity 406 (FIG. 9). The cavity 406 is sized and configured to receive a controller 408. The controller 408 may be a digital circuit, having a microprocessor for example, or an analog circuit. In one embodiment, the controller 408 is in asynchronous bidirectional communication with the electronic data processing system 210 (FIGS. 2 and 3). The communication connection between the controller 408 and the electronic data processing system 210 may be wired (e.g. via controller 420) or may be a direct or indirect wireless connection (e.g. Bluetooth or IEEE 802.11) or a combination of wired and wireless connections. In the exemplary embodiment, the enclosure 402 is formed in two halves 410, 412, such as from an injection molded plastic material for example. The halves 410, 412 may be secured together by fasteners, such as screws 414 for example. In other embodiments, the enclosure halves 410, 412 may be secured together by adhesives or ultrasonic welding for example.

The handle portion 404 also includes buttons or actuators 416, 418 that may be manually activated by the operator. The actuators 416, 418 are coupled to the controller 408 that transmits a signal to a controller 420 within the probe housing 102. In the exemplary embodiments, the actuators 416, 418 perform the functions of actuators 422, 424 located on the probe housing 102 opposite the device 400. It should be appreciated that the device 400 may have additional switches, buttons or other actuators that may also be used to control the device 400, the AACMM 100 or vice versa. Also, the device 400 may include indicators, such as light emitting diodes (LEDs), sound generators, meters, displays or gauges for example. In one embodiment, the device 400 may include a digital voice recorder that allows for synchronization of verbal comments with a measured point. In yet another embodiment, the device 400 includes a microphone that allows the operator to transmit voice activated commands to the electronic data processing system 210.

In one embodiment, the handle portion 404 may be configured to be used with either operator hand or for a particular hand (e.g. left handed or right handed). The handle portion 404 may also be configured to facilitate operators with disabilities (e.g. operators with missing finders or operators with prosthetic arms). Further, the handle portion 404 may be removed and the probe housing 102 used by itself when clearance space is limited. As discussed above, the probe end 401 may also comprise the shaft of the seventh axis of AACMM 100. In this embodiment the device 400 may be arranged to rotate about the AACMM seventh axis.

The probe end 401 includes a mechanical and electrical interface 426 having a first connector 429 (FIG. 8) on the device 400 that cooperates with a second connector 428 on the probe housing 102. The connectors 428, 429 may include electrical and mechanical features that allow for coupling of the device 400 to the probe housing 102. In one embodiment, the interface 426 includes a first surface 430 having a mechanical coupler 432 and an electrical connector 434 thereon. The enclosure 402 also includes a second surface 436 positioned adjacent to and offset from the first surface 430. In the exemplary embodiment, the second surface 436 is a planar surface offset a distance of approximately 0.5 inches from the first surface 430. As will be discussed in more detail below, this offset provides a clearance for the operator's fingers when tightening or loosening a fastener such as collar 438. The interface 426 provides for a relatively quick and secure electronic connection between the device 400 and the probe housing 102 without the need to align connector pins, and without the need for separate cables or connectors.

The electrical connector 434 extends from the first surface 430 and includes one or more connector pins 440 that are electrically coupled in asynchronous bidirectional communication with the electronic data processing system 210 (FIGS. 2 and 3), such as via one or more arm buses 218 for example. The bidirectional communication connection may be wired (e.g. via arm bus 218), wireless (e.g. Bluetooth or IEEE 802.11), or a combination of wired and wireless connections. In one embodiment, the electrical connector 434 is electrically coupled to the controller 420. The controller 420 may be in asynchronous bidirectional communication with the electronic data processing system 210 such as via one or more arm buses 218 for example. The electrical connector 434 is positioned to provide a relatively quick and secure electronic connection with electrical connector 442 on probe housing 102. The electrical connectors 434, 442 connect with each other when the device 400 is attached to the probe housing 102. The electrical connectors 434, 442 may each comprise a metal encased connector housing that provides shielding from electromagnetic interference as well as protecting the connector pins and assisting with pin alignment during the process of attaching the device 400 to the probe housing 102.

The mechanical coupler 432 provides relatively rigid mechanical coupling between the device 400 and the probe housing 102 to support relatively precise applications in which the location of the device 400 on the end of the arm portion 104 of the AACMM 100 preferably does not shift or move. Any such movement may typically cause an undesirable degradation in the accuracy of the measurement result. These desired results are achieved using various structural features of the mechanical attachment configuration portion of the quick connect mechanical and electronic interface of an embodiment of the present invention.

In one embodiment, the mechanical coupler 432 includes a first projection 444 positioned on one end 448 (the leading edge or “front” of the device 400). The first projection 444 may include a keyed, notched or ramped interface that forms a lip 446 that extends from the first projection 444. The lip 446 is sized to be received in a slot 450 defined by a projection 452 extending from the probe housing 102 (FIG. 8). It should be appreciated that the first projection 444 and the slot 450 along with the collar 438 form a coupler arrangement such that when the lip 446 is positioned within the slot 450, the slot 450 may be used to restrict both the longitudinal and lateral movement of the device 400 when attached to the probe housing 102. As will be discussed in more detail below, the rotation of the collar 438 may be used to secure the lip 446 within the slot 450.

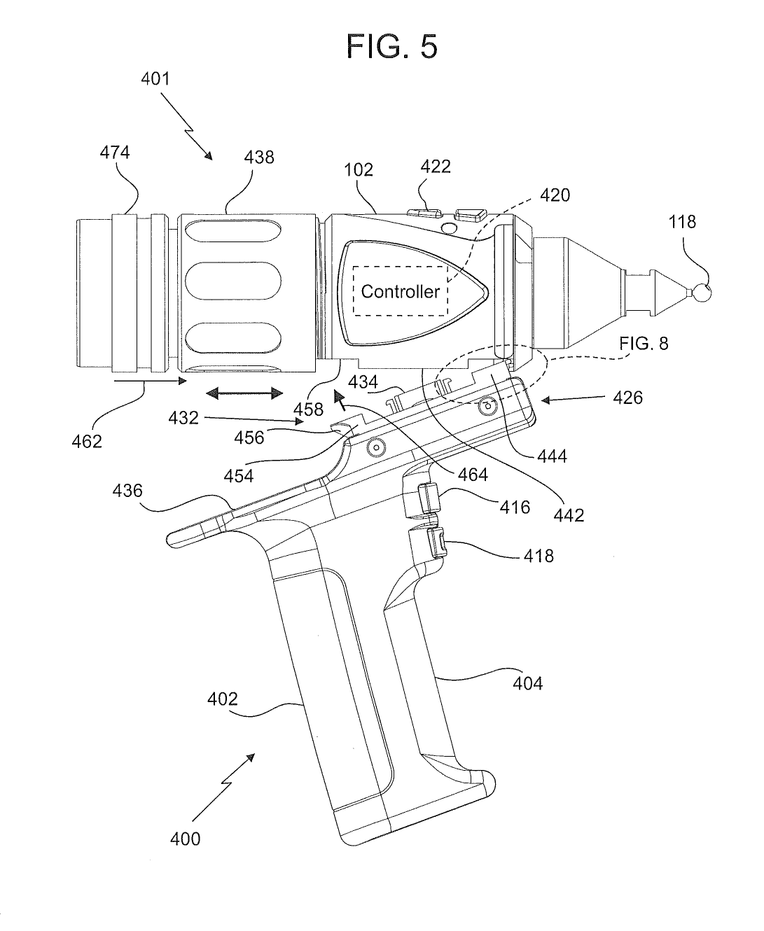

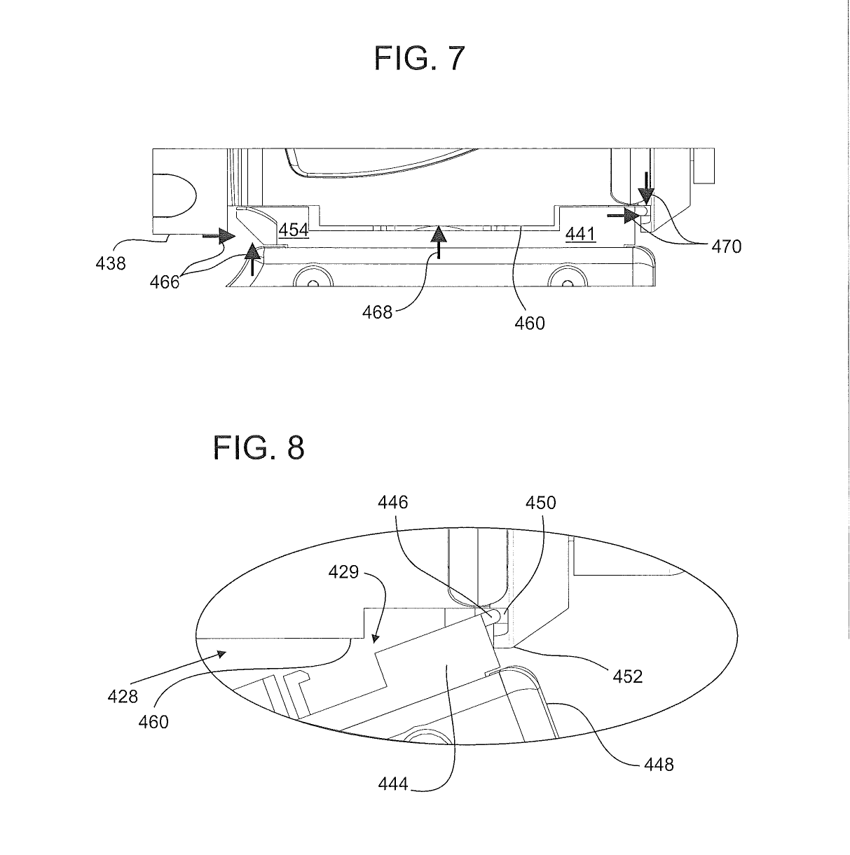

Opposite the first projection 444, the mechanical coupler 432 may include a second projection 454. The second projection 454 may have a keyed, notched-lip or ramped interface surface 456 (FIG. 5). The second projection 454 is positioned to engage a fastener associated with the probe housing 102, such as collar 438 for example. As will be discussed in more detail below, the mechanical coupler 432 includes a raised surface projecting from surface 430 that adjacent to or disposed about the electrical connector 434 which provides a pivot point for the interface 426 (FIGS. 7 and 8). This serves as the third of three points of mechanical contact between the device 400 and the probe housing 102 when the device 400 is attached thereto.

The probe housing 102 includes a collar 438 arranged co-axially on one end. The collar 438 includes a threaded portion that is movable between a first position (FIG. 5) and a second position (FIG. 7). By rotating the collar 438, the collar 438 may be used to secure or remove the device 400 without the need for external tools. Rotation of the collar 438 moves the collar 438 along a relatively coarse, square-threaded cylinder 474. The use of such relatively large size, square-thread and contoured surfaces allows for significant clamping force with minimal rotational torque. The coarse pitch of the threads of the cylinder 474 further allows the collar 438 to be tightened or loosened with minimal rotation.

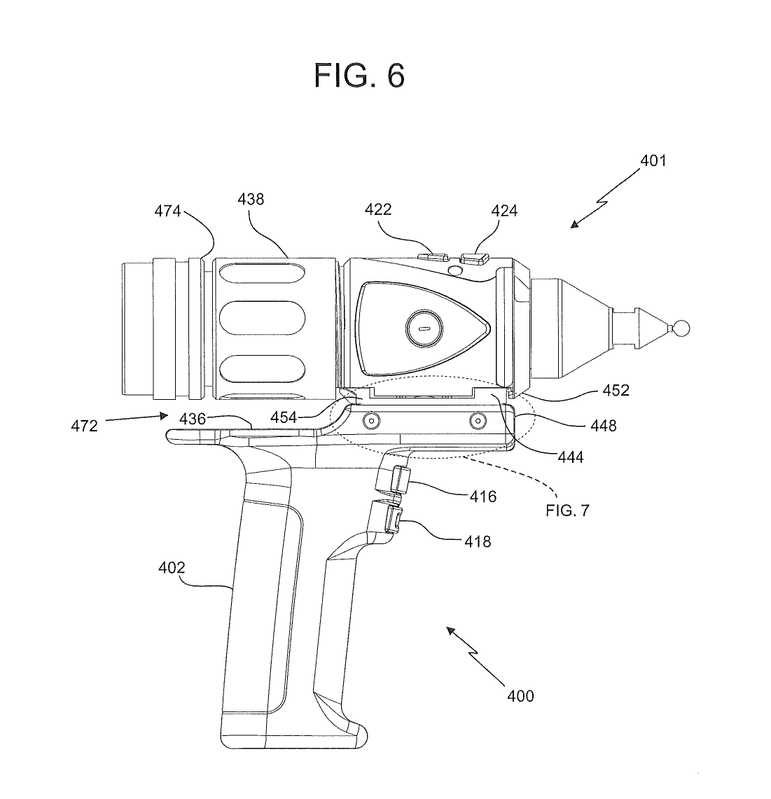

To couple the device 400 to the probe housing 102, the lip 446 is inserted into the slot 450 and the device is pivoted to rotate the second projection 454 toward surface 458 as indicated by arrow 464 (FIG. 5). The collar 438 is rotated causing the collar 438 to move or translate in the direction indicated by arrow 462 into engagement with surface 456. The movement of the collar 438 against the angled surface 456 drives the mechanical coupler 432 against the raised surface 460. This assists in overcoming potential issues with distortion of the interface or foreign objects on the surface of the interface that could interfere with the rigid seating of the device 400 to the probe housing 102. The application of force by the collar 438 on the second projection 454 causes the mechanical coupler 432 to move forward pressing the lip 446 into a seat on the probe housing 102. As the collar 438 continues to be tightened, the second projection 454 is pressed upward toward the probe housing 102 applying pressure on a pivot point. This provides a see-saw type arrangement, applying pressure to the second projection 454, the lip 446 and the center pivot point to reduce or eliminate shifting or rocking of the device 400. The pivot point presses directly against the bottom on the probe housing 102 while the lip 446 is applies a downward force on the end of probe housing 102. FIG. 5 includes arrows 462, 464 to show the direction of movement of the device 400 and the collar 438. FIG. 7 includes arrows 466, 468, 470 to show the direction of applied pressure within the interface 426 when the collar 438 is tightened. It should be appreciated that the offset distance of the surface 436 of device 400 provides a gap 472 between the collar 438 and the surface 436 (FIG. 6). The gap 472 allows the operator to obtain a firmer grip on the collar 438 while reducing the risk of pinching fingers as the collar 438 is rotated. In one embodiment, the probe housing 102 is of sufficient stiffness to reduce or prevent the distortion when the collar 438 is tightened.

Embodiments of the interface 426 allow for the proper alignment of the mechanical coupler 432 and electrical connector 434 and also protect the electronics interface from applied stresses that may otherwise arise due to the clamping action of the collar 438, the lip 446 and the surface 456. This provides advantages in reducing or eliminating stress damage to circuit board 476 mounted electrical connectors 434, 442 that may have soldered terminals. Also, embodiments provide advantages over known approaches in that no tools are required for a user to connect or disconnect the device 400 from the probe housing 102. This allows the operator to manually connect and disconnect the device 400 from the probe housing 102 with relative ease.

Due to the relatively large number of shielded electrical connections possible with the interface 426, a relatively large number of functions may be shared between the AACMM 100 and the device 400. For example, switches, buttons or other actuators located on the AACMM 100 may be used to control the device 400 or vice versa. Further, commands and data may be transmitted from electronic data processing system 210 to the device 400. In one embodiment, the device 400 is a video camera that transmits data of a recorded image to be stored in memory on the base processor 204 or displayed on the display 328. In another embodiment the device 400 is an image projector that receives data from the electronic data processing system 210. In addition, temperature sensors located in either the AACMM 100 or the device 400 may be shared by the other. It should be appreciated that embodiments of the present invention provide advantages in providing a flexible interface that allows a wide variety of accessory devices 400 to be quickly, easily and reliably coupled to the AACMM 100. Further, the capability of sharing functions between the AACMM 100 and the device 400 may allow a reduction in size, power consumption and complexity of the AACMM 100 by eliminating duplicity.

In one embodiment, the controller 408 may alter the operation or functionality of the probe end 401 of the AACMM 100. For example, the controller 408 may alter indicator lights on the probe housing 102 to either emit a different color light, a different intensity of light, or turn on/off at different times when the device 400 is attached versus when the probe housing 102 is used by itself In one embodiment, the device 400 includes a range finding sensor (not shown) that measures the distance to an object. In this embodiment, the controller 408 may change indicator lights on the probe housing 102 in order to provide an indication to the operator how far away the object is from the probe tip 118. This provides advantages in simplifying the requirements of controller 420 and allows for upgraded or increased functionality through the addition of accessory devices.

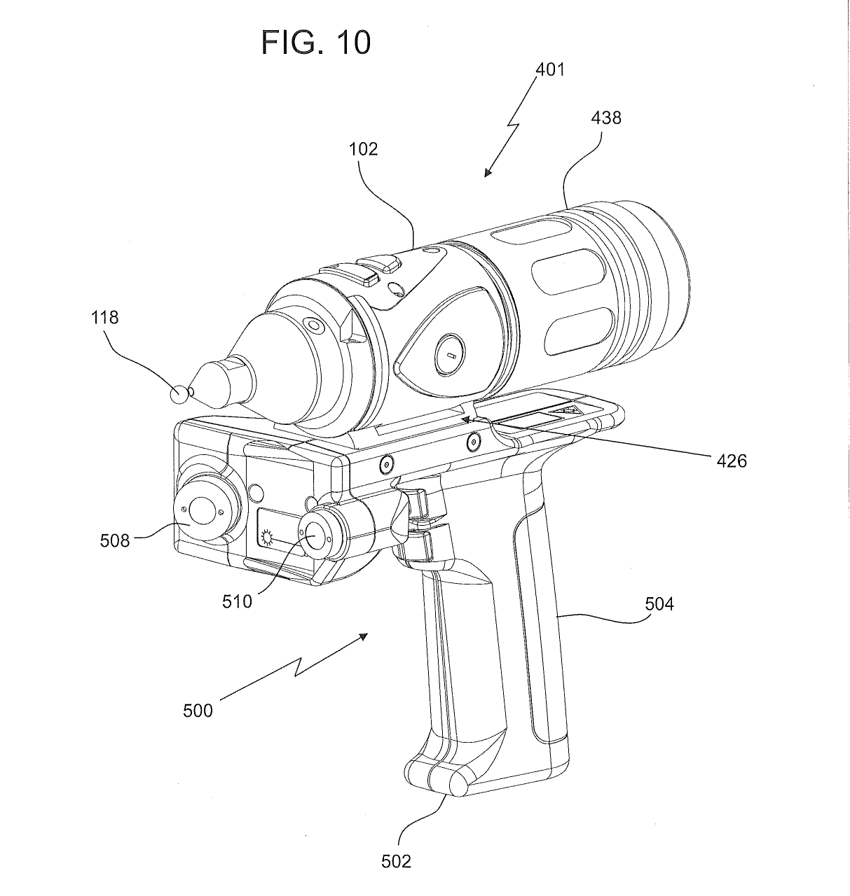

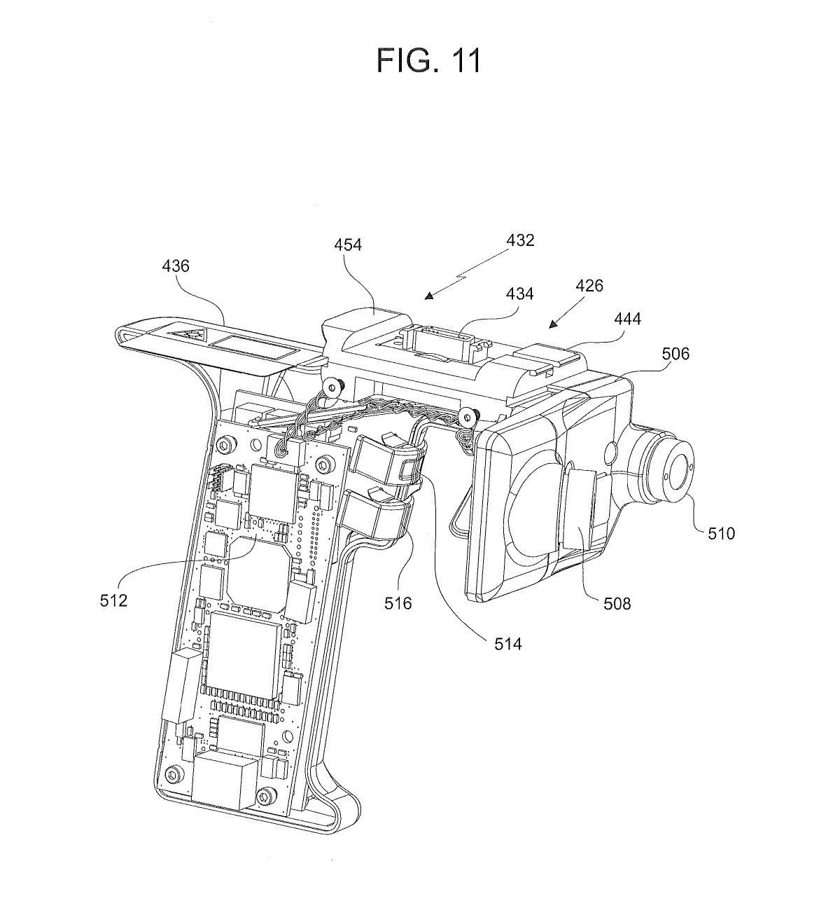

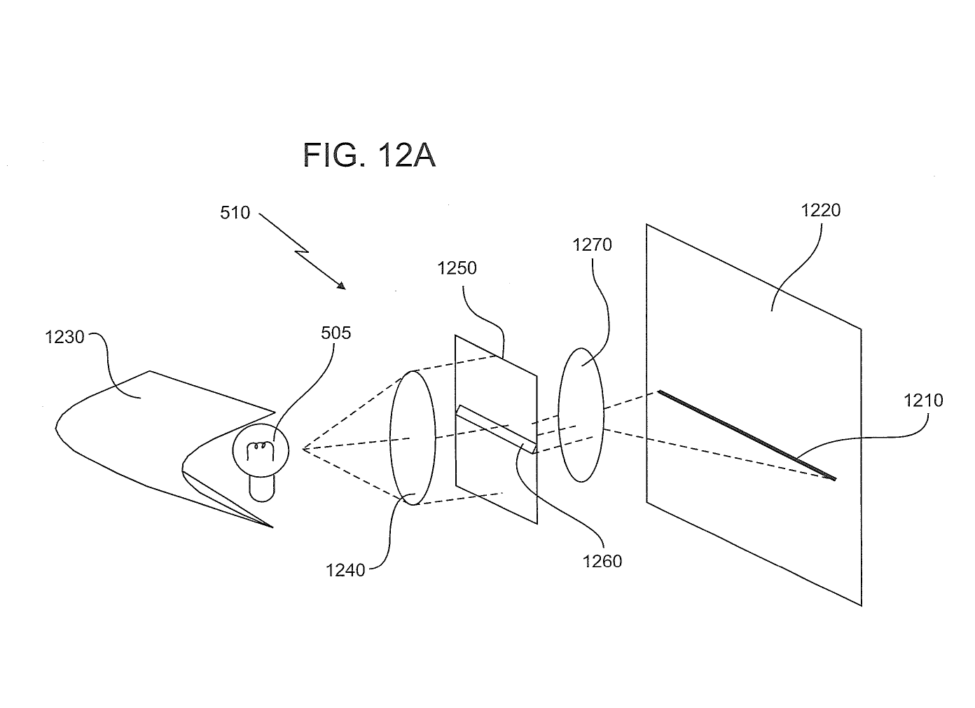

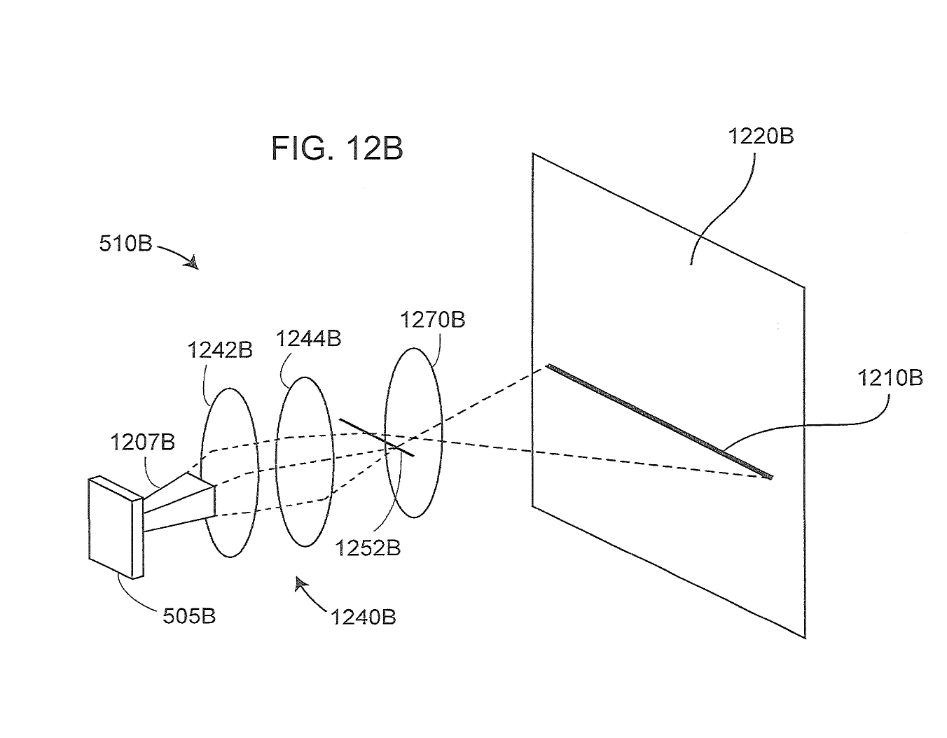

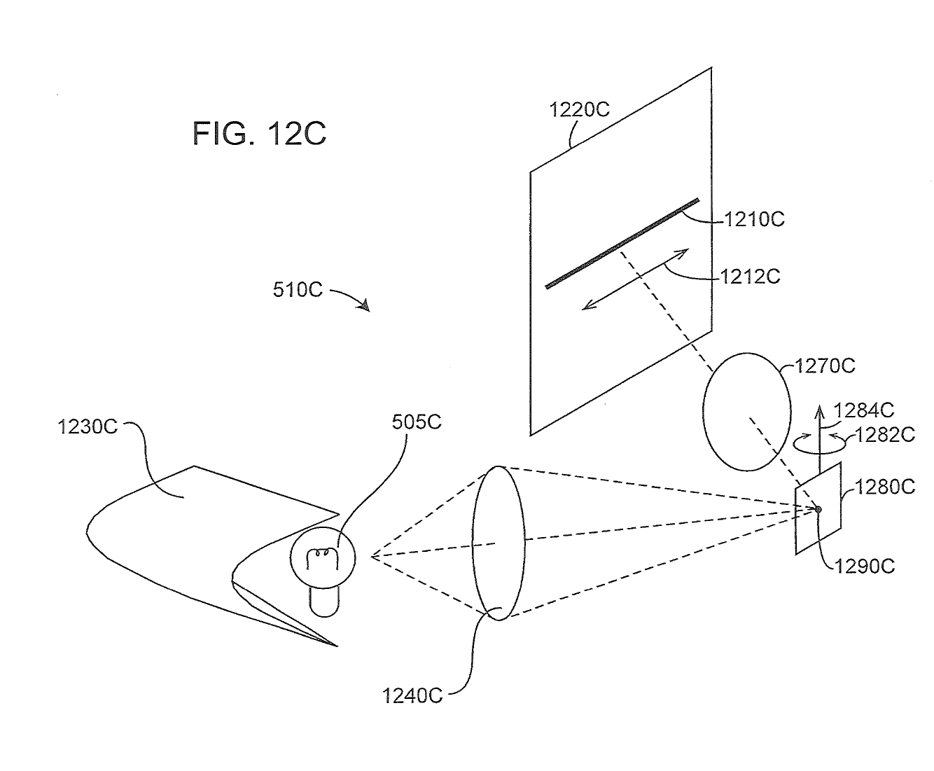

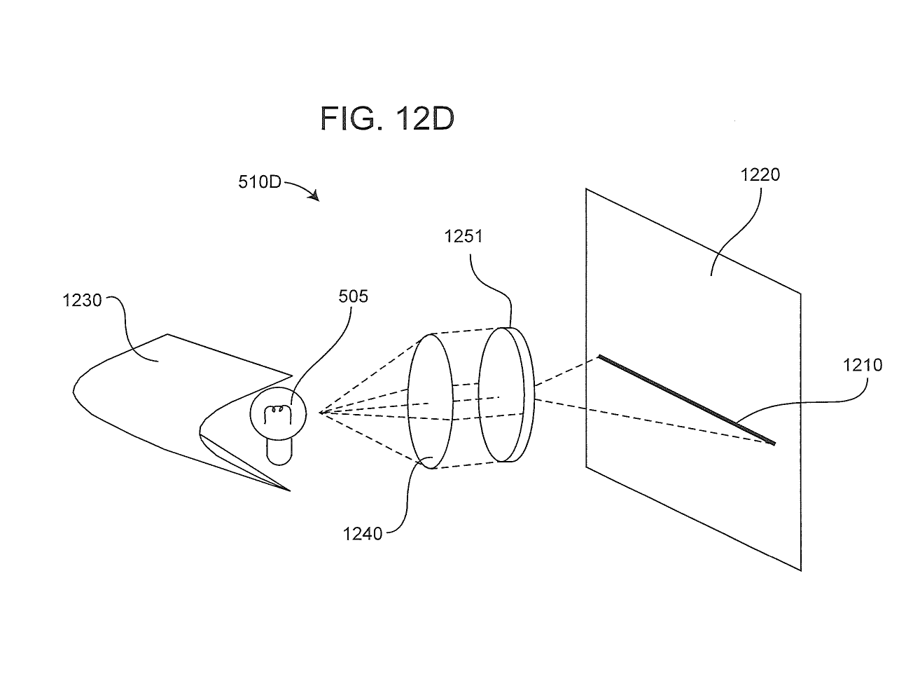

Referring to FIGS. 10-11, embodiments of the present invention provide advantages to camera, signal processing, control and indicator interfaces for a line scanner device 500 that functions as an accessory device for the AACMM 100. The line scanner 500 may be similar to a laser line probe (LLP) with the exception that the line scanner utilizes a non-laser light source (e.g., a light emitting diode, also known as an LED, a Xenon lamp, an incandescent lamp, a superluminescent diode, a halogen lamp) together with additional corresponding components, in contrast to a typical LLP which uses a laser light source. The line scanner 500 is described in more detail herein after with respect to FIGS. 12-14, in accordance with embodiments of the present invention.

A characteristic that distinguishes a laser light source from a non-laser light source is the coherence length. A laser light source typically has a coherence length of anywhere from a millimeter to hundreds of meters, depending on the type of laser. Non-laser light sources, on the other hand, typically have a coherence length less than one millimeter and, in many cases, only a few micrometers or less. Speckle is a phenomenon that arises from light scattered off small surface irregularities that, arriving at a photosensitive array, coherently interfere to produce an irregular and noisy pattern of light. Light from non-laser sources interfere incoherently or with partial coherence, thereby eliminating or greatly reducing speckle and the noise produced by speckle. As used herein, the term low-coherence light source is synonymous with the term non-laser light source.

The line scanner 500 includes an enclosure 502 with a handle portion 504. The line scanner 500 may also include the quick connect mechanical and electrical interface 426 of FIGS. 4-9, described in detail herein above, located on one end that mechanically and electrically couples the line scanner 500 to the probe housing 102 as described herein above. The interface 426 allows the line scanner 500 to be coupled to and removed from the AACMM 100 quickly and easily without requiring additional tools. However, it is to be understood that the line scanner 500 of embodiments of the present invention may utilize other types of electrical and/or mechanical interfaces to attach the line scanner 500 to the AACMM. Further, the line scanner 500 may be permanently attached to the AACMM or to other devices, instead of being removably attached through use of the interface 426.

Adjacent the interface 426, the enclosure 502 includes a portion 506 that includes projector 510 and a camera 508. The camera 508 may include a charge-coupled device (CCD) type sensor or a complementary metal-oxide-semiconductor (CMOS) type sensor for example. In the exemplary embodiment, the projector 510 and camera 508 are arranged at an angle such that the camera 508 may detect reflected light from the projector 510. In one embodiment, the projector 510 and the camera 508 are offset from the probe tip 118 such that the line scanner 500 may be operated without interference from the probe tip 118. In other words, the line scanner 500 may be operated with the probe tip 118 in place. Further, it should be appreciated that the line scanner 500 is substantially fixed relative to the probe tip 118 so that forces on the handle portion 504 do not influence the alignment of the line scanner 500 relative to the probe tip 118. In one embodiment, the line scanner 500 may have an additional actuator (not shown) that allows the operator to switch between acquiring data from the line scanner 500 and the probe tip 118.

The projector 510 and camera 508 are electrically coupled to a controller 512 disposed within the enclosure 502. The controller 512 may include one or more microprocessors, digital signal processors, memory and signal conditioning circuits. Due to the digital signal processing and large data volume generated by the line scanner 500, the controller 512 may be arranged within the handle portion 504. The controller 512 is electrically coupled to the arm buses 218 via electrical connector 434. The line scanner 500 further includes actuators 514, 516 which may be manually activated by the operator to initiate operation and data capture by the line scanner 500.

FIG. 12A is a schematic diagram of the line-scanner projector 510 of FIG. 11 that includes the non-laser light source 505 which is used to project a single line 1210 onto an object 1220 to be measured, in accordance with an embodiment of the present invention. The non-laser light source 505 may comprise an LED, Xenon lamp, or some other suitable type of non-laser light source. An optional reflector 1230 is used to reflect the light from the light source 505 towards a beam delivery system 1240, which directs the light at a slide mask 1250 that has a single line slit or opening 1260 formed therein. The optional reflector may be, for example, a parabolic type reflector, for example, such as a miniature version of the type often found in automobiles for example. This type of reflector produces light that is approximately collimated. The beam delivery system 1240 may include a condensing lens assembly having one or more spherical lenses or aspheric lenses. The beam delivery system 1240 may include a tapered light pipe rod, which collects light from the light source 505, partially collimates the light, and provides light of approximately constant irradiance at the exit window of the light pipe. If the beam from the light source 505 is elliptical, the beam delivery system 1240 may include an anamorphic prism pair or a cylinder lens to make the beam circular. The light delivered to the slide mask 1250 from the beam delivery system 1240 may be a collimated beam or a converging beam that illuminates an area only slightly larger than the slit of the slide mask 1250. In other words, the area of illumination encompasses the slit of slide mask 1250. The opening 1260 allows the single line of light 1210 to pass through and onto an objective lens 1270, which images the single line of light 1210 onto the object 1220 to be measured. In other words, the objective lens is positioned relative to the slit of the slide mask 1250 so as to make the image of the edges of the slit relatively sharp at the position of the object. In general, the object may be moved a little closer to the lens or a little farther from the lens so that the edges of the slit image are not perfectly sharp but at least relatively sharp. Another way of saying this is that light at the position of the slit (or the position of the mask) are imaged onto the object. Thus, the optional reflector 1230, beam delivery system 1240, slide mask 1250 and objective lens 1270 comprise components that take the non-laser light emitted by the light source 505 and provide a single line of light 1210 onto the object to be measured 1220. Other component schemes for achieving this result may be utilized in light of the teachings herein. The single line of light 1210 scatters off of the object 1220 and travels back to the camera 508 for signal processing.

In the embodiment of FIG. 12A, the projector 510 emits light having the color of red, which results in a red line for the single line of light 1210 on the object to be measured. However, other colors of light, including white light, may be emitted by the light source 505, thereby forming the single line of light 1210 in the color of light emitted by the light source 505.

For all of the embodiments discussed herein, characteristics of the camera are known, such as the distance from the camera lens system to the photosensitive array, the focal length of the lens system, and pixel size and spacing of the photosensitive array for example. In some cases, it may be desirable to know and correct the aberrations of the lens system, such as distortion. Numerical values to provide such aberration correction may be obtained by carrying out experiments using the camera for example. In one type of experiment, for example, the camera may be used to measure the positions of dots located at known positions on a plate.

For the embodiments discussed herein, it is also desirable to know the relative spacings and orientations of projector elements for example. For example, the distance from the projector to the camera and the angle of tilt of each relative to the axis that connects the projector and camera are known. The geometry of the projected pattern relative to the mechanical projector assembly is also known.

Another embodiment of a line scanner is shown in FIG. 12B that eliminates the use of a slide mask 1250. The projector 510B includes a light source 505B and a beam delivery system 1240B that includes a collimator lens 1242B and a cylindrical lens 1244B that focuses the light into a line 1252B, which is imaged by the objective lens 1270B onto the object under test 1220B. Advantages of this approach include elimination of the slide mask 1250 and the use of all the light in the beam, thereby enabling more light to reach the object 1220B as projected line 1210B. As discussed above, the beam delivery system may be constructed in many ways. In the example shown in FIG. 12B, light is coupled from a light source 505B, which might be an LED, for example, into a light pipe 1207B which is placed close to the exit aperture of the LED. The light exiting the light pipe expands as it travels to the collimator lens 1242B. Many other beam delivery systems are possible, and the embodiments described herein do not limit the beam delivery systems that may be used.

In FIG. 12C, an embodiment of a line-scanner projector 510C produces a dot 1290C that is scanned by a beam deflector 1280C to produce a straight line 1210C on an object 1220C, thereby producing the laser stripe (line) 1210C by an indirect means. In the projector 510C, light comes from a non-laser light source 505C. The beam deflector 1280C may be a rotating mirror—for example, a galvanometer mirror, or it may be a collection of mirrors assembled into the shape of a polygon, the polygon rotated as an assembly. The beam deflector might also be a non-moving device such as an acousto-optic (AO) modulator. The light from the beam deflector 1280C is sent to the objective lens 1270C, which forms an image of the moving spot 1290C on the object under test 1220C. The objective lens may be an f-theta lens, which has the property of displacing the light by an amount proportional to an angular change (theta).

In FIG. 12D, a schematic diagram is illustrated of the line-scanner projector 510D of FIG. 11 that includes the non-laser light source 505 which is used to project a single line 1210 onto an object 1220 to be measured, in accordance with an embodiment of the present invention. Similar to the embodiment of FIG. 12A, the non-laser light source 505 may comprise an LED, Xenon lamp, or some other suitable type of non-laser light source. An optional reflector 1230 is used to reflect the light from the light source 505 towards a beam delivery system 1240, as described herein above. The beam delivery system 1240 may include a condensing lens assembly having one or more spherical lenses or aspheric lenses. The beam delivery system 1240 may include a tapered light pipe rod, which collects light from the light source 505, partially collimates the light, and provides light of approximately constant irradiance at the exit window of the light pipe. If the beam from the light source 505 is elliptical, the beam delivery system 1240 may include an anamorphic prism pair or a cylinder lens to make the beam circular. The light from the beam delivery system 1250 is delivered to an apodizing filter 1251. The light received by the apodizing filter 1251 may be a collimated beam or a converging beam. In an embodiment, light is emitted from the apodizing filter and travels to the object 1220 as a straight line 1210. The single line of light 1210 scatters off of the object 1220 and travels back to the camera 508 for signal processing. In one embodiment, the apodizing filter 1251 is a diffractive optical element such as a model DE-R 283 manufactured by HOLOEYE Photonics AG for example. The apodizing filter 1251 may be made from glass or a plastic material such as polycarbonate or polymethyl methacrylate for example.

In the embodiment of FIG. 12D, the projector 510 emits light having the color of red, which results in a red line for the single line of light 1210 on the object to be measured. However, other colors of light, including white light, may be emitted by the light source 505, thereby forming the single line of light 1210 in the color of light emitted by the light source 505.

In addition to the methods of beam delivery and imaging described herein above, there are many other configurations that can be made to produce a line of light at an object, where the light is derived from a low-coherence light source.

The line scanner described in the present application sends a line of laser light onto an object, which is scattered off the object, and passes the scattered light into a camera lens that directs the light onto a two-dimensional photosensitive array. The photosensitive array might be a charge coupled device (CCD) array or a complementary metal oxide semiconductor (CMOS) array, for example. The principle by which a line scanner determines the three-dimensional coordinates of surface points is fundamentally different than the principle by which a structured light scanner determines the three dimensional coordinates of an object surface. As is explained in more detail below, a line scanner uses a first dimension of a photosensitive array to determine the position of the light along the direction of the stripe (line) and a second dimension of the photosensitive array to determine the distance to the object surface. By this means, three-dimensional coordinates of the object surface may be obtained. In contrast, a structured light scanner must use both dimensions of a photosensitive array to determine the pattern of light scattered by the object surface. Consequently, in a structured light scanner, an additional means is needed to determine the distance to the object. In many structured light scanners, the distance is obtained by collecting multiple consecutive frames of camera information with the pattern changed in each frame. For example, in some structured light scanners, the pattern is changed by varying the phase and pitch of fringes in the pattern. Since multiple exposures are necessary with such a method, it is not usually possible with this method to accurately capture the three-dimensional coordinates of a rapidly moving object. In other structured light scanners, a coded pattern is projected onto the object surface. By analysis of the overall pattern of light at the camera, detailed features of the object can be deduced. This method permits measurements to be made of moving objects, but accuracy is not usually as good as with a structured light scanner that collects several frames of camera information to determine the three-dimensional coordinates of a stationary object.

In the past, it has been relatively common to derive a structured light pattern from low-coherence light—for example, by sending such light through a slide mask (e.g. chrome on glass) or by using a micro-electromechanical system (MEMS), liquid crystal on silicon (LCOS), or similar device. However, for line scanners, laser light has been the source used in prior art systems since it has been believed to have desirable characteristics for focusing laser light into small spots and sharp lines. However, it has been found that low-coherence light may be used to produce spots and lines. The use of low-coherence light provides a substantial advantage over prior art laser line scanners because a low-coherence source reduces the effect of speckle, which as explained above is a contributor to line scanner noise and error.

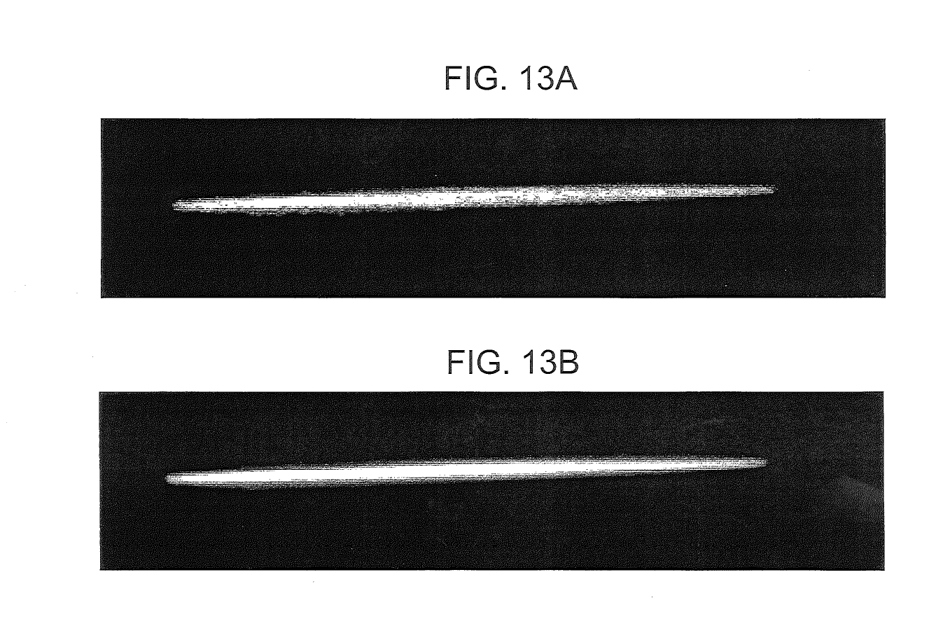

An example of the advantage that can be obtained by reducing the coherence length of laser light in a line scanner is illustrated in FIGS. 13A and 13B. FIG. 13A shows a stripe obtained from a laser source. FIG. 13B shows the same stripe after the light was reflected off a small membrane vibrated in a variety of modes and over a large number of frequencies. By reflecting the light off the vibrating membrane, the coherence length of the laser light was reduced and, as a result, the speckle was reduced. As can be seen by comparing the images of FIGS. 13A and 13B, the reduction in speckle resulted in a smoother line. It is clear that the center of the stripe along the strip length can be more accurately calculated for the speckle reduced stripe of FIG. 13B than for the stripe of FIG. 13A. Unfortunately, the method of using a vibrating membrane is expensive and so a more economical approach is desired. The use of a low-coherence light source is such an approach. It has been found that low-coherent light sources, including LEDs, are capable of producing thin, sharp lines with smooth intensities, and the reduction of speckle helps to keep the ends of the lines sharp.

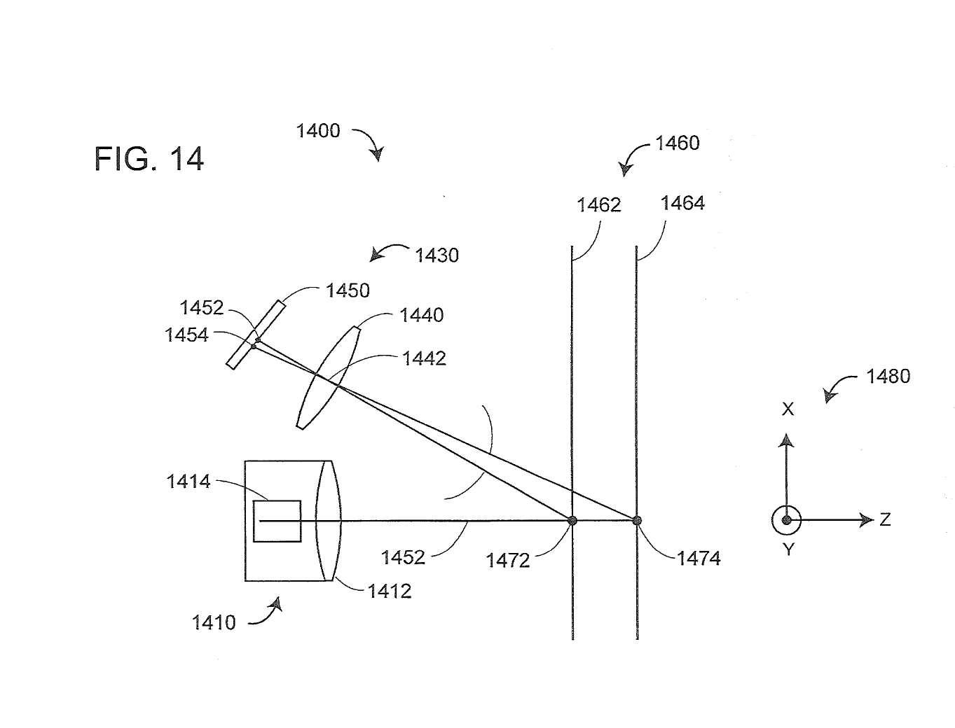

The principle of operation of a line scanner is shown schematically in FIG. 14. A top view of a line scanner 1400 includes a projector 1410 and a camera 1430, the camera including a lens system 1440 and a photosensitive array 1450 and the projector including an objective lens system 1412 and a pattern generator 1414. The pattern generator may include a low-coherence light source and a beam delivery system. The projector 1410 projects a line 1452 (shown in the figure as projecting out of the plane of the paper) onto the surface of an object 1460, which may be placed at a first position 1462 or a second position 1464. Light scattered from the object at the first point 1472 travels through a perspective center 1442 of the lens system 1440 to arrive at the photosensitive array 1450 at position 1452. Light scattered from the object at the second position 1474 travels through the perspective center 1442 to arrive at position 1454. By knowing the relative positions and orientations of the projector 1410, the camera lens system 1440, the photosensitive array 1450, and the position 1452 on the photosensitive array, it is possible to calculate the three-dimensional coordinates of the point 1472 on the object surface. Similarly, knowledge of the relative position of the point 1454 rather than 1452 will yield the three-dimensional coordinates of the point 1474. The photosensitive array 1450 may be tilted at an angle to satisfy the Scheimpflug principle, thereby helping to keep the line of light on the object surface in focus on the array.

One of the calculations described herein above yields information about the distance of the object from the line scanner—in other words, the distance in the z direction, as indicated by the coordinate system 1480 of FIG. 14. The information about the x position and y position of each point 1472 or 1474 relative to the line scanner is obtained by the other dimension of the photosensitive array 1450, in other words, the y dimension of the photosensitive array. Since the plane that defines the line of light as it propagates from the projector 1410 to the object is known from the coordinate measuring capability of the articulated arm, it follows that the x position of the point 1472 or 1474 on the object surface is also known. Hence all three coordinates—x, y, and z—of a point on the object surface can be found from the pattern of light on the two-dimensional array 1450.

The non-laser light source 505 has been described herein above with respect to embodiments of a line scanner 500 in which the light source 505 is included within an accessory device or as an attachment to a portable AACMM 100. However, this is for exemplary purposes and the claimed invention should not be so limited. Other embodiments of the line scanner 500 utilizing a non-laser light source 505 are contemplated by the present invention, in light of the teachings herein. For example, the line scanner 500 with the non-laser light source 505 may be utilized in a fixed or non-articulated arm (i.e., non-moving) CMM. Other fixed inspection installations are contemplated as well. For example, a number of such line scanners 500 may be strategically placed in fixed locations for inspection or measurement purposes along some type of assembly or production line; for example, for automobiles.

While the invention has been described with reference to example embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A line scanner configured to measure an object, comprising:
a non-laser light source that emits light;
a beam delivery system;
a mask wherein the beam delivery system is configured to deliver the light from the light source to the mask, the mask having a portion substantially opaque to the light from the beam delivery system and a single transmissive region through which the light is transmitted, the transmissive region being substantially in the shape of a single line;
a first lens system configured to substantially image the light transmitted through and located at the transmissive region onto the object;
a camera that includes a second lens system and a photosensitive array, the camera having predetermined characteristics including a focal length of the second lens system and a position of the photosensitive array relative to the second lens system, and wherein the second lens system is configured to collect the light reflected by or scattered off the object as a first collected light and image the first collected light onto the photosensitive array, the photosensitive array configured to convert the first collected light into an electrical signal;
a housing to which are attached in a rigid and predetermined geometrical configuration the non-laser light source, the beam delivery system, the mask, the first lens system, and the camera; and
an electronic circuit including a processor, wherein the electronic circuit is configured to calculate three dimensional coordinates of a plurality of points of light imaged on the object by the first lens system, the points of light being a part of the light imaged onto the object, the three dimensional coordinates based at least in part on the electrical signal, the camera characteristics, and the geometrical configuration.

2. The line scanner of claim 1, wherein the light source comprises a light emitting diode.

3. The line scanner of claim 1, wherein the light source comprises one of a Xenon lamp, an incandescent lamp, and a halogen lamp.

4. The line scanner of claim 1, wherein the beam delivery system comprises a condensing lens.

5. The line scanner of claim 1, wherein the beam delivery system includes one of a light pipe and a reflector.

6. The line scanner of claim 1, wherein the second lens system comprises an objective lens.

7. The line scanner of claim 1, wherein the line scanner is configured to be attached to a portable articulated arm coordinate measuring machine.

8. The line scanner of claim 1, wherein the line scanner is configured to be attached at a fixed location on a part assembly line.

9. The line scanner of claim 1, wherein the line scanner is configured to be portable and handheld.

10. A line scanner configured to measure an object, comprising:
a non-laser light source that emits light;
a beam delivery system;
an apodizing filter arranged to receive light from the beam delivery system, the apodizing filter configured to output the light received from the beam delivery system in substantially the shape of a single line of light, the single line of light perpendicular to the direction of propagation of the light;
a first lens system configured to receive the single line of light from the apodizing filter and image the single line of light onto the object;
a camera that includes a second lens system and a photosensitive array, the camera having predetermined characteristics including a focal length of the second lens system and a position of the photosensitive array relative to the second lens system, and wherein the second lens system is configured to collect the light reflected by or scattered off the object as a first collected light and image the first collected light onto the photosensitive array, the photosensitive array configured to convert the first collected light into an electrical signal;
a housing to which are attached in a rigid and predetermined geometrical configuration the non-laser light source, the beam delivery system, the first lens system, and the camera; and
an electronic circuit including a processor, wherein the electronic circuit is configured to calculate three dimensional coordinates of a plurality of points of light imaged on the object by the first lens system, the points of light being a part of the light imaged onto the object, the three dimensional coordinates based at least in part on the electrical signal, the camera characteristics, and the geometrical configuration.

11. The line scanner of claim 10, wherein the light source comprises a light emitting diode.

12. The line scanner of claim 10, wherein the light source comprises one of a Xenon lamp, an incandescent lamp, and a halogen lamp.

13. The line scanner of claim 10, wherein the beam delivery system comprises a condensing lens.

14. The line scanner of claim 10, wherein the beam delivery system includes one of a light pipe and a reflector.

15. The line scanner of claim 10, wherein the apodizing filter includes a diffractive optical element.

16. The line scanner of claim 10, wherein the line scanner is configured to be attached to a portable articulated arm coordinate measuring machine.

17. The line scanner of claim 10, wherein the line scanner is configured to be attached at a fixed location on a part assembly line.

18. The line scanner of claim 10, wherein the line scanner is configured to be portable and handheld.
